(19) United States
(12) Patent Application Publication
(10) Pub. No.: US 2007/0080028 A1
(43) Pub. Date: Apr. 12, 2007

(54) Device and method for measuring slack and tread depth

(76) Inventor: Lloyd J. Pinel, Third Lake, IL (US)

Correspondence Address: THE LAW OFFICES OF ROBERT T. BRAUN, 10810 TURNLEAF LANE, TUSTIN RANCH, CA, 92782, US

(21) Appl. No.: 11/247,085

(22) Filed: Oct. 11, 2005

(51) Int. Cl. F16D 66/02

(52) U.S. Cl. 188/1.11 R

(57) ABSTRACT

A device and method for measuring slack in a vehicle braking system is described. The device includes an elongated body and a slidable member disposed within a channel of the elongated body. The elongated body has markings for measuring distance, and the slidable member may have a flange or magnet on one end. The slidable member slides out from one end of the elongated body and contacts a fixed compartment. The vehicle braking system is then activated and the movement of the push rod is measured. The other end of the slidable member may be narrow and contain depth markings for measuring tread depth of tires.

### BACKGROUND OF THE INVENTION

1. Field of the Invention

This patent relates to compliance with regulatory and safety guidelines regarding motor vehicles. In particular, this patent relates to devices and methods for measuring the slack in air brakes and tire tread depth.

2. Summary of Related Art

Air brake systems on vehicles commonly have an air pressure chamber with a diaphragm or piston. A push rod is connected at one end to the diaphragm or piston, and at the other end to a cam. The cam is connected to brake pads located opposite brake linings. As the vehicle operator presses the brake pedal, air is admitted to the chamber, forcing the diaphragm or piston to move. This moves the push rod, which in turn moves the cam, causing the brake pads to contact the brake linings. This produces friction, which slows or stops the vehicle.

The distance the push rod has to travel is called its stroke. As the brake pads or linings wear, the push rod stroke has to increase to slow or stop the vehicle, creating slack in the braking system. Also, the brake pads and linings can be out of alignment, again causing increased push rod stroke and slack.

Increased slack requires more pressure on the brake pedal by the vehicle operator, and more pressure in the air chamber to slow or stop the vehicle. This increases braking distance, and in some cases can cause the brakes to fail completely. It is critical to control slack for the proper functioning of air brake systems, for safety and performance.

In order to control slack, air brake systems have slack adjusters. These slack adjusters reposition the push rod so that the proper push rod stroke is maintained. If the stroke is too long, the braking system may not generate enough braking power to safely stop the vehicle. If the stroke is too short, the brake may drag, increasing friction and causing overheating.

Several countries and states have adopted regulations concerning the appropriate push rod stroke for various air brake systems. When the stroke is outside the allowable limits, either the slack needs to be adjusted or the brake needs to be repaired or replaced. In order to determine when such adjustment or repair is required, the push rod stroke needs to be measured.

When functioning properly, the air brake system slows rotation of the tires to slow or stop the vehicle. Ultimately, however, the slowing needs to be translated from the tires to the road or ground. When braking, tires with insufficient tread depth will lose traction, causing the brakes to “lock” and the vehicle to slide. To achieve maximum braking efficiency, and therefore maximum safety, the tires on the vehicle must have sufficient tread depth.

The United States Department of Transportation has instituted regulations that require vehicle operators to measure both push rod stroke and tread depth on a regular, often daily, basis. In addition, many fire departments and other commercial vehicle operators have instituted additional such requirements. These are typically measured at the same time, and kept in a written log.

Measuring the push rod stroke has traditionally been done with a ruler or tape measure. First, the position of the push rod is measured with the brake pedal released, then measured with the brake pedal depressed. These two measurements were then subtracted to determine the push rod stroke. This method, while relatively simple, suffers from several disadvantages.

The push rods are generally in dark places that are difficult to access. The measurer either needs to find enough ambient light to read the ruler or tape measure, or hold a light while trying to make the measurements. Errors in measurement can occur as a result.

Many rulers and tape measures are marked with English measurements on one side and metric measurements on the other. Because both the left and right side brakes must be measured, often the measurer needs to hold the ruler or tape measure upside down. Errors in measurement can occur as a result.

The method also requires the measurer to take a measurement, remember it, take another measurement, remember it, then subtract the two. This can result in errors due to lapses of memory or mathematical mistakes.

Several prior art systems have tried to address these problems. U.S. Pat. No. 4,583,071 to Sebalos et al. discloses an automatic brake adjustment monitoring device to be mounted to the brake system which warns the vehicle operator when brakes were in need of adjustment or repair.

U.S. Pat. No. 4,776,438 to Schandelmeier discloses a brake adjustment indicator to be mounted to the brake system which indicates when the push rod stroke moves beyond a preset position.

U.S. Pat. No. 4,800,991 to Miller discloses a brake maintenance monitor to be mounted to the brake system which indicates when the push rod stroke moves beyond a predetermined distance.

U.S. Pat. No. 4,864,900 to Kreikle et al. discloses a testing and adjusting tool for air brake cams which allows testing of the push rod stroke by manually rotating the cam, rather than depressing the brake pedal.

U.S. Pat. No. 4,879,964 to Emerson, Jr., discloses an air brake adjustment marker to be mounted to the brake system. When the push rod stroke moves beyond a predetermined length, a chain disconnects from the air canister, dropping a flag which alerts the vehicle operator.

U.S. Pat. No. 4,991,310 to Melia discloses a brake chamber stroke indicator in which a bracket is mounted to the push rod, and a grooved probe is slid across the bracket. The number of grooves that pass across the bracket give a general indication of the condition of the brakes, without actually measuring the push rod stroke.

U.S. Pat. No. 5,044,302 to Goldfein et al. discloses a spring-activated brake wear indicator mountable to the push rod which visually indicates excessive wear without actually measuring the push rod stroke.

U.S. Pat. No. 5,213,056 to Nicholls et al. discloses a slack adjustment tester which mounts against the air canister and the slack adjustment arm to provide a measurement of the push rod stroke.

Each of these methods suffers from one or more of the disadvantages listed above. Additionally, most are relatively expensive for a commercial vehicle operator which may have several or even dozens of vehicles. Also, for the systems which are fixed to the brake system, one device must be fixed to each brake on a vehicle that needs to be tested or monitored.

### SUMMARY OF THE INVENTION

In accordance with the present invention, there is provided a device for providing a measurement of the slack between movement of an air chamber and brake pads contacting brake linings in a vehicle braking system having a push rod connected to the air chamber. The device has an elongated body, preferably of plastic, with a channel extending longitudinally from one end toward the other. The channel preferably has a T-shaped cross-section with the opening narrower than the full width of the channel. The opening can be on the top or the bottom of the elongated body.

A slidable member is disposed within the channel, such that it can extend from one end of the elongated body toward the air chamber. The slidable member is preferably made of plastic. The end of the slidable member that extends from the elongated body may have a flange suitable for contacting a fixed surface in the vehicle braking system. Whether or not there is a flange, the end may include a magnet to allow the end to magnetically connect with the fixed surface. Preferably, the slidable member fits snugly within the channel, so that it resists sliding except when the user applies slight force. To facilitate application of this slight force, the slidable member preferably has one or more protrusions extending out of the opening of the channel.

The elongated body has markings to measure the length of movement of the push rod when the vehicle braking system is activated. These markings preferably occur at regular intervals, more preferably every quarter of an inch.

The markings are visible when viewed from the top of the elongated body, and may be visible when viewed from the sides. The markings are preferably luminescent or fluorescent, to facilitate viewing in dark places.

In accordance with another aspect of the present invention, the opposite end of the slidable member may be narrow, able to extend from the other end of the elongated body, and contains depth markings to indicate depth of a tire tread. These markings would preferably occur at regular intervals, more preferably every one thirty-second of an inch. The markings may also include an indicator of unsafe tread depth, such as a different colored depth marking.

In accordance with another aspect of the present invention, a method is provided for measuring the slack between the movement of an air chamber and brake pads contacting brake linings in a vehicle braking system having a push rod connected to the air chamber, where the air chamber is within a fixed compartment. The method comprises placing a measuring device near the push rod, extending an anchor member from the measuring device against the fixed compartment, activating the vehicle braking system, and taking a single measurement to determine the distance moved by the push rod. Preferably, the measuring device will be placed adjacent to the push rod. The measuring device may be placed near a recognizable feature either on the push rod or one that moves substantially in the same direction and the same distance as the push rod when the vehicle braking system is activated.

In accordance with another aspect of the present invention, the anchor member magnetically attached to the fixed compartment.

In accordance with another aspect of the present invention, the measuring device has a zero measurement marking, and this zero measurement marking is placed near or adjacent to the push rod or recognizable feature.

In taking a single measurement, the user can mark the position of the recognizable feature, such as by placing his thumb or another finger on the measuring device next to the recognizable feature. Thereafter, the user can read the position of the recognizable feature to determine the distance moved. This can occur after the user has exited from under the vehicle and is in a more lighted environment.

It is an object of the present invention to provide a simplified method and device for measuring slack in a vehicle braking system. The present invention allows the user to take a single measurement to determine the amount of slack. Further, the present invention does not require attachment to the moving parts of the vehicle braking system.

It is an object of the present invention to provide a method and device that can be reversed for left side and right side brakes. The present invention has markings that extend to either edge of the top of the elongated body.

It is an object of the present invention to provide a method and device suitable for measurement in low light areas where vehicle braking systems are typically found. The present invention has luminescent or fluorescent markings to facilitate reading measurements in such areas. Also, the present invention is suitable for marking the movement of the push rod, even as simply as with a thumb or other finger, and reading the measurement after exiting to a brighter area.

It is an object of the present invention to allow a single device to provide the two generally-required measurements for commercial vehicles: amount of slack and tread depth. The present invention combines a slack measurement device with a tread depth measurement device.

The above, as well as other advantages of the present invention, will become readily apparent to those skilled in the art from the following detailed description of a preferred embodiment when considered in light of the accompanying drawings.

### BRIEF DESCRIPTION OF THE DRAWINGS

The foregoing and other objects, features and advantages of the invention will be apparent from the following more particular description of a preferred embodiment of the invention as illustrated in the accompanying drawings wherein:

FIG. 1 shows a cross-sectional view of a vehicle air braking system suitable for use with the present invention.

FIG. 2 shows a cross-sectional view of the vehicle air braking system shown in FIG. 1 when activated.

FIG. 3 shows a top view of an embodiment of the measurement device, according to the present invention.

FIG. 4 shows a bottom view of an embodiment of the measurement device, according to the present invention.

FIG. 5 shows a top view of the elongated body of the measurement device, according to an embodiment of the present invention.

FIG. 6 shows a view of the slidable member of the measurement device, according to an embodiment of the present invention.

FIG. 7 shows a first step in a method of using the present invention.

FIG. 8 shows a second step in a method of using the present invention.

### DESCRIPTION OF THE PREFERRED EMBODIMENT

Throughout the drawing figures, the same reference numeral has been used to label the same feature or element.

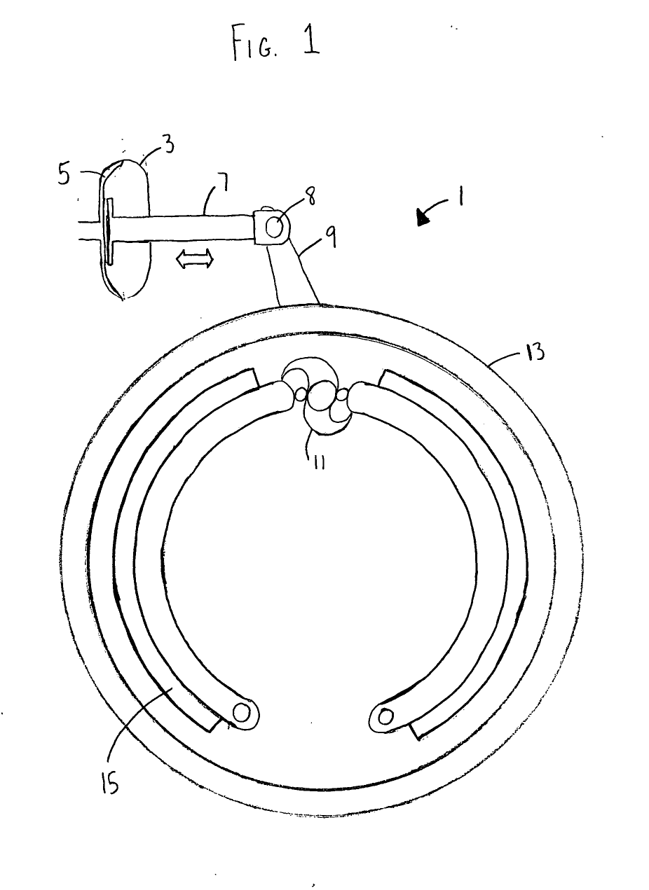

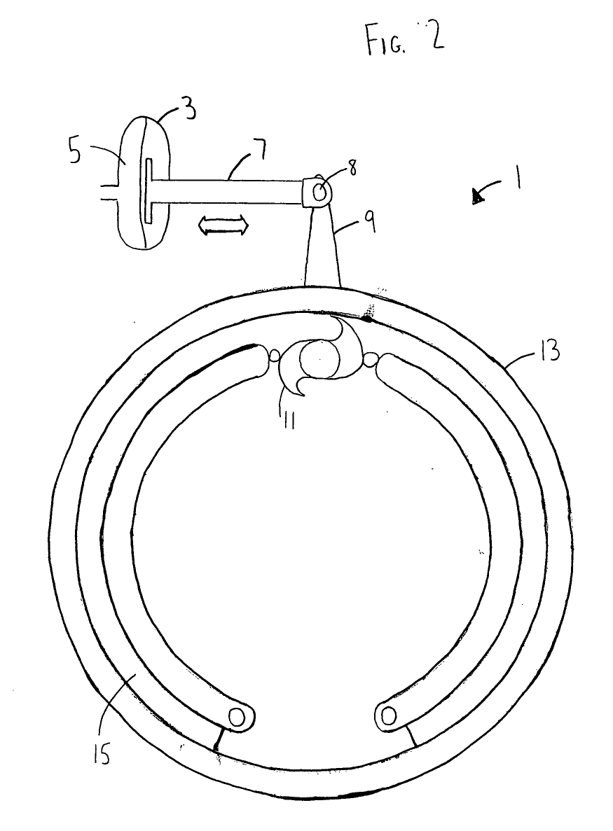

Referring generally to FIGS. 1 and 2, there is shown a vehicle braking system 1 suitable for use with the present invention. The vehicle braking system 1 consists of an air cylinder 3 containing an expandable air chamber 5. A push rod 7 is connected to the expandable air chamber 5, and extends out of the air cylinder 3. At the other end, push rod 7 is connected to a slack adjuster 9 by a pin 8. The slack adjuster 9 is connected to a brake cam shaft (not shown), which is in turn connected to an S-cam 11 within a brake drum 13. Some commercial braking systems 1 do not contain slack adjusters 9. In those systems, another connection between the push rod 7 and the brake cam shaft (not shown) is suitable. The S-cam 11 is attached to brake pads 15, or brake shoes.

In vehicle braking systems 1 with manual slack adjusters instead of the automatic slack adjuster 9 shown, the push rod 7 will be connected to an arm which is in turn connected to the brake cam shaft (not shown). This alternate configuration does not change the present invention or its use.

When the vehicle braking system 1 is disengaged, as shown in FIG. 1, the expandable air chamber 5 is empty. The push rod 7 is at or near its left-most position, as viewed in FIG. 1. The slack adjuster 9 is also disposed slightly toward the air cylinder 3. When the push rod 7 and slack adjuster 9 are in this position, a brake return spring (not shown) biases the S-cam 11 to the position shown so that the brake pads 15 do not wear against the inside surface of the brake drum 13.

FIG. 2 shows the vehicle braking system 1 of FIG. 1 when activated. The driver presses the brake pedal, causing air to enter the expandable air chamber 5. As the expandable air chamber 5 expands, the push rod 7 is moved to the right (as viewed in the figure). This moves the slack adjuster 9 to the right, turning the brake cam shaft (not shown) and the S-cam 11. This rotation of the S-cam 11 forces the brake pads 15 outward, bringing them into contact with the inside surface of the brake drum 13. This contact causes friction, which slows the vehicle.

Under normal circumstances, the vehicle braking system 1 is adjusted so that the brake pads 15 do not wear excessively against the brake drum 13. As the brake pads 15 or brake drum 13 wear, then the brake pads 15 must move outwardly a greater and greater distance to contact the brake drum 13. This requires greater movement of the push rod 7 and greater expansion of the expandable air chamber 5. This greater movement is referred to as slack. Improper alignment can also cause slack, as can the heating of the brake drum 13, which causes expansion.

Slack is problematic in braking systems for two reasons. Too little slack causes the brake pads 15 to wear excessively against the brake drum 13. This shortens the life of the brake pads 15 and can damage braking systems. Too much slack requires more effort to slow the vehicle. This leads to increased stopping distance and, in extreme cases, brake failure. So, for maximum performance and safety, slack must be adjusted to proper levels.

Slack adjusters 9 help solve the problem. However, in order to determine the proper adjustment for slack, it must be measured.

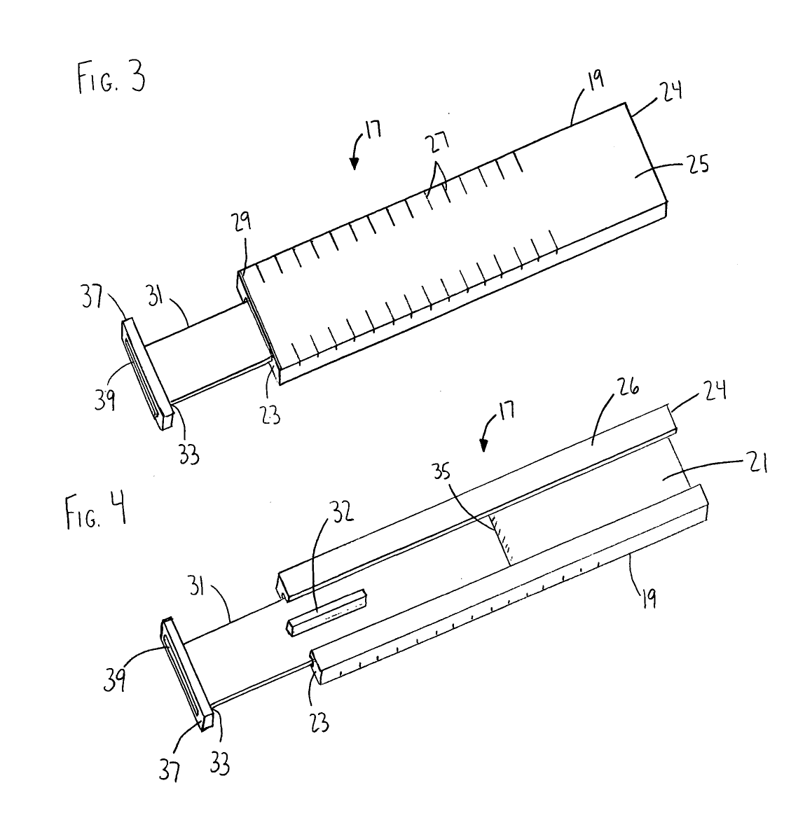

Referring generally to FIGS. 3 and 4, there is shown a top and bottom view of one embodiment of a slack measurement device 17 according to the present invention. The slack measurement device 17 comprises an elongated body 19. The elongated body 19 is preferably made of plastic, and is preferably of rectangular shape and cross-section, with the corners and edges preferably rounded or beveled slightly for safety. The elongated body 19 has a top 25 and a bottom 26, and defines a channel 21 which extends longitudinally from a first end 23 toward the other, second end 24 of the elongated body 19. The channel 21 preferably, although not necessarily, extends the entire length of the elongated body 19, and preferably has a T-shaped cross-section, as seen more clearly in FIG. 4. The channel 21 has an opening narrower than the full width of the channel 21. The opening can be on the top 25 or the bottom 26 of the elongated body 19.

On the top 25 of the elongated body 19 are markings 27. The markings 27 indicate the distance from a zero measurement marking 29 located at or near the first end 23 of the elongated body 19. Preferably, the markings 27 are at regular intervals, and most preferably each quarter inch. In order to facilitate use of the slack measurement device 17 for both left side and right side brakes, the markings 27 preferably either extend completely across the top 25 of the elongated body 19, or have similar or identical markings 27 on either edge of the top 25 of the elongated body 19. In either case, the markings 27 are preferably visible from the top 25 of the elongated body 19. Most preferably, the markings 27 extend over the edge of the top 25 of the elongated body 19, such that they are also visible from the side of the elongated body 19. Also, it is preferable for the markings 27 contain measurement numbers and tick marks. As will be described later, these markings 27 measure the length of movement of the push rod 7 when the vehicle braking system 1 is activated.

Because vehicle braking systems 1 are located underneath a vehicle, which is typically a dark area, the markings 27 are preferably luminescent or fluorescent. This facilitates viewing in a dark area.

Disposed within the channel 21 is a slidable member 31, preferably made of plastic. Because of the T-shaped cross section of the channel 21, the elongated body 19 completely encloses the slidable member 31 on three sides, and partially on a fourth side. In the embodiment shown in FIGS. 3 and 4, the fourth side is the bottom 26 of the elongated body 19. The slidable member 31 is shaped to fit within the channel 21 to be able to slide longitudinally without any substantial lateral movement or wobbling. Preferably, the slidable member 31 fits snugly within the channel 21, so that it will not slide without application of a slight force from a user. To facilitate the application of this slight force, the slidable member 31 preferably has a protrusion 32 extending out of the fourth side of the elongated body 19.

The slidable member 31 has a first end 33 and a second end 35. The first end 33 of the slidable member 31 is disposed toward the first end 23 of the elongated body 19, and the second end 35 of the slidable member 31 is disposed toward the second end 24 of the elongated body 19.

In operation, the first end 33 of the slidable member 31 extends from the first end 23 of the elongated body 19, toward the expandable air chamber 5 of the vehicle braking system 1. This first end 33 of the slidable member 31 is placed against a fixed surface of the vehicle braking system 1, such as the air cylinder 3. The first end 33 of the slidable member 31 may have a flange 37 to provide more surface area to contact the air cylinder 3. This flange 37 may be larger than the cross section of the channel 21, and preferably is the same size and shape as the cross section of the elongated body 19. Additionally, whether or not the first end 33 of the slidable member 31 has a flange 37, it may include a magnet 39 to provide magnetic contact with the air cylinder 3.

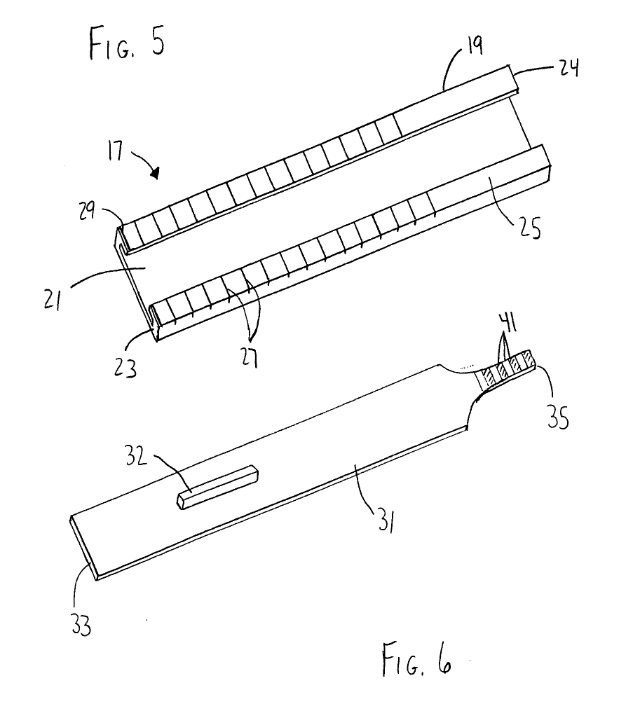

Referring to FIG. 5, there is shown a second embodiment of the elongated body 19. As in the previous embodiment, this embodiment of the elongated body 19 has a first end 23, and second end 24, a top 25, and a bottom (not shown). The elongated body 19 encloses a channel 21 with a T-shaped cross-section which extends from the first end 23 toward the second end 24. In this embodiment, the channel 21 opens on the top 25 of the elongated body 19, rather than on the bottom, as shown in the previous embodiment. Additionally, the markings 27 are on either side of the channel 21, and also preferably extend extend over the edge of the top 25 of the elongated body 19, such that they are also visible from the side of the elongated body 19.

Referring to FIG. 6, there is shown a second embodiment of the slidable member 31. As in the previous embodiment, the slidable member 31 has a protrusion 32, and first end 33 and a second end 35. This embodiment of the slidable member 31 does not have a flange on the first end 33, but may contain a magnet (not shown). The second end 35 of the slidable member 31 is substantially narrower than the remainder of the slidable member 31. The second end 35 of the slidable member 31 is narrow enough to fit between the treads of a tire.

There are depth markings 41 on the second end 35 of the slidable member 31. Preferably, the depth markings 41 are on more than one side of the slidable member 31, and preferably on opposite sides. Preferably, the depth markings 41 occur at regular intervals, which are preferably every one thirty-secondth of an inch. In is also preferable for the depth markings 41 to indicate an unsafe tread depth, preferably with a different colored one of the depth markings 41. In operation, the second end 35 of the slidable member 31 extends from the second end 24 of either embodiment of the elongated body 19. The user inserts the second end 35 of the slidable member 31 between the treads of a tire, and reads the measurement of the tread depth.

It should be recognized that either embodiment of the elongated body 19 can be modified to work with either embodiment of the slidable member 31. Additionally, either embodiment of the elongated body 19 can be modified to work with a channel 21 either that extends the entire length of the length of the elongated body 19, or that does not extend all the way to the second end 24 of the elongated body 19.

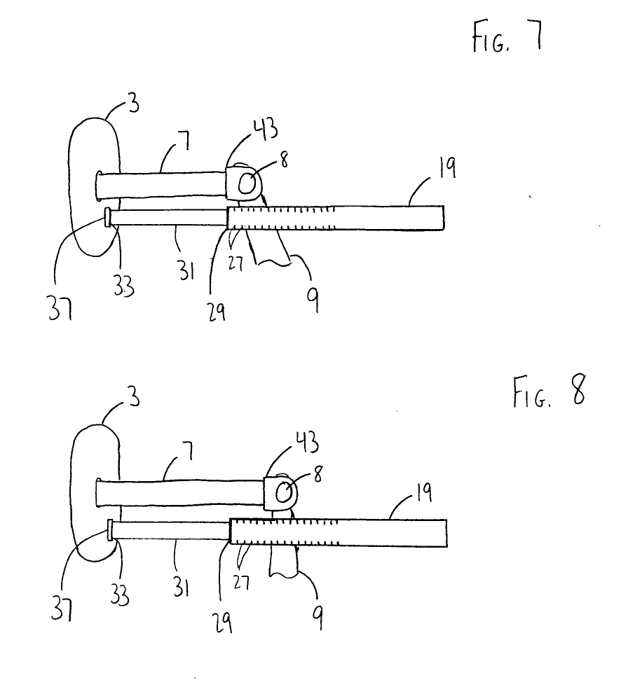

The preferred method of operation of the present invention is shown in FIGS. 7 and 8. FIG. 7 shows the placement of the present invention before the vehicle braking system 1 is activated. FIG. 8 shows the placement of the present invention after the vehicle braking system 1 has been activated.

The user places the slack measurement device 17 near the push rod 7. Preferably, the slack measurement device 17 is placed adjacent to the push rod 7, The user then extends the slidable member 31 from the elongated body 19 toward the air cylinder 3 of the vehicle braking system 1. The first end 33 of the slidable member 31, with or without the flange 37 or magnet (not shown), contacts the air cylinder 3. If a magnet (not shown) is present, then the first end 33 of the slidable member 31 is magnetically attached to the air cylinder 3. It should be noted that the air cylinder 3 is a fixed compartment within the vehicle braking system 1, and does not move when the vehicle braking system 1 is activated. The slidable member 31 therefore acts as an anchor member for the slack measurement device 17.

The vehicle braking system 1 is then activated, causing the push rod 7 to move longitudinally along the elongated body 19. The preferred method for activating the vehicle braking system 1 is to have a second user depress the brake pedal (not shown). An alternative method is for the first user to use a pry bar to manually move the push rod 7.

Under either method, the resulting movement of the push rod 7 is shown in FIG. 8. The first user then takes a single measurement from the markings 27 on the elongated body 19 to determine the distance moved by the push rod 7.

Because the push rod 7 moves longitudinally along its axis, it may be difficult to directly measure the movement of the push rod 7. Therefore, it is preferable to place the first end 23 of the elongated body 19 near a recognizable feature which moves substantially the same direction and distance as the push rod 7 when the vehicle braking system 1 is activated. The recognizable feature preferably is a component of the vehicle braking system 1. An example of a suitable recognizable feature is the bracket 43 connecting the push rod 7 to the slack adjuster 9 as shown, or preferably the center of the pin 8 attaching the push rod 7 to the slack adjuster 9. After the vehicle braking system 1 is activated, the user takes the single measurement from the markings 27 to determine the distance moved by the recognizable feature or bracket 43, which will be substantially identical to the distance moved by the push rod 7.

It is preferable to place the zero measurement marking 29 on the elongated body 19 near the push rod 7, recognizable feature, or bracket 43. By doing this, the user can determine the distance moved simply by reading the marking 27 closest to the push rod 7, recognizable feature, or bracket 43 after the vehicle braking system 1 has been activated, as shown in FIG. 8.

Because of the low light condition near most vehicle braking systems 1, the user can mark the position of the push rod 7, recognizable feature, or bracket 43 on the elongated body 19, and read the position later when the ambient light is higher. This act of marking can be as simple as placing a thumb or other finger on the elongated body 19 next to the push rod 7, recognizable feature, or bracket 43. Then the user can exit from underneath the vehicle and read the marking 27 closest to his finger or other mark.

In accordance with the provisions of the patent statutes, the present invention has been described in what is considered to represent its preferred embodiment. However, it should be noted that the invention can be practiced otherwise than as specifically illustrated and described without departing from its spirit and scope.

What I claim is:

1. A device for providing a measurement of the slack between movement of an air chamber and brake pads contacting brake linings in a vehicle braking system having a push rod connected to the air chamber, comprising:
an elongated body having a first end and a second end, and having a channel extending from said first end longitudinally toward said second end;
a slidable member having a first end and a second end, disposed within said channel such that said first end of said slideable member is able to extend from said first end of said elongated body toward the air chamber;
markings on said elongated body to measure the length of movement of the push rod when the vehicle braking system is activated.

2. A device as in claim 1, further comprising a flange on said first end of said slidable member disposed to contact a fixed surface in the vehicle braking system.

3. A device as in claim 1, wherein said first end of said slidable member includes a magnet.

4. A device as in claim 2, wherein said flange includes a magnet.

5. A device as in claim 1, wherein:
said elongated body has a top and a bottom; and
said markings are visible when viewed from said top of said elongated body.

6. A device as in claim 5, wherein said markings are visible when viewed from the sides of said elongated body orthogonal to said top and said first end.

7. A device as in claim 5, wherein said markings are visible on either edge of said top of said elongated body.

8. A device as in claim 1, wherein said slidable member fits snugly within said channel such that said slidable member resists sliding without application of slight force.

9. A device as in claim 8, wherein said channel has a T-shaped cross-section such that said elongated body encloses said slidable member completely on three sides and partially on a fourth side.

10. A device as in claim 9, wherein said fourth side is said top of said elongated body.

11. A device as in claim 9, wherein said fourth side is said bottom of said elongated body.

12. A device as in claim 1, further comprising a protrusion attached to said slidable member to facilitate application of force to said slidable member.

13. A device as in claim 1, wherein said markings are luminescent.

14. A device as in claim 1, wherein said markings are fluorescent.

15. A device as in claim 1, wherein said markings occur at regular intervals on said elongated body.

16. A device as in claim 15, wherein said markings occur at intervals of one quarter of an inch.

17. A device as in claim 1, wherein said elongated body is plastic.

18. A device as in claim 17, wherein said slidable member is plastic.

19. A device as in claim 1, wherein:
said second end of said slidable member is able to extend from said second end of said elongated body;
said second end of said slidable member is narrow; and
said second end of said slidable member contains depth markings to indicate depth of a tire tread.

20. A device as in claim 19, wherein said depth markings occur at regular intervals on said second end of said slidable member.

21. A device as in claim 20, wherein said depth markings occur at intervals of one thirty-secondth of an inch.

22. A device as in claim 19, wherein said depth markings further include an indicator of unsafe tread depth.

23. A device as in claim 22, wherein said indicator is a different colored one of said depth markings.

24. A method of measuring the slack between movement of an air chamber and brake pads contacting brake linings in a vehicle braking system having a push rod connected to the air chamber, wherein the air chamber is within a fixed compartment, comprising:
placing a measuring device having a first end near the push rod;
extending from the first end of the measuring device an anchor member such that a first end of the anchor member contacts the fixed compartment;
activating the vehicle braking system to move the push rod; and
taking a single measurement to determine the distance moved by the push rod.

25. A method as in claim 24, wherein the step of placing comprises placing the measuring device adjacent to the push rod.

26. A method as in claim 24, wherein:
the step of placing comprises placing a first end of the measuring device near a recognizable feature which moves substantially the same direction and distance as the push rod when the vehicle braking system is activated; and
the step of taking a single measurement comprises measuring the distance moved by the recognizable feature.

27. A method as in claim 24, wherein the step of taking a single measurement comprises measuring the distance moved by a component of the vehicle braking system which moves substantially the same direction and distance as the push rod when the vehicle braking system is activated.

28. A method as in claim 24, wherein said step of extending further comprises magnetically attaching the first end of the anchor member to the fixed compartment.

29. A method as in claim 26, wherein said step of extending further comprises magnetically attaching the first end of the anchor member to the fixed compartment.

30. A method as in claim 24, wherein the measuring device has a zero measurement marking near the first end, and wherein said step of placing comprises placing the zero measurement marking near the push rod so that any distance moved will be relative to the zero measurement marking.

31. A method as in claim 25, wherein the measuring device has a zero measurement marking near the first end, and wherein said step of placing comprises placing the zero measurement marking adjacent to the push rod so that any distance moved will be relative to the zero measurement marking.

32. A method as in claim 26, wherein the measuring device has a zero measurement marking near the first end, and wherein said step of placing comprises placing the zero measurement marking next to the recognizable feature so that any distance moved will be relative to the zero measurement marking.

33. A method as in claim 26, wherein the step of taking a single measurement comprises the substeps of:
marking the position of the recognizable feature; and
reading the position of the recognizable feature.

34. A method as in claim 33, wherein the substep of marking the position comprises placing a finger on the measuring device next to the recognizable feature.

35. A method as in claim 24, wherein the step of activating the vehicle braking system comprises manually moving the push rod with a pry bar.
